(19) United States
(12) Patent Application Publication
(10) Pub. No.: US 2026/0369003 A1
(43) Pub. Date: Nov. 19, 2026

(54) BINNING WITH LRZ ON STENCIL ENABLED SURFACES

(71) Applicant: QUALCOMM Incorporated, San Diego, CA (US)

(72) Inventors: Xuefeng TANG, San Diego, CA (US); Kevin MATLAGE, Erie, CO (US); Orlando AGUILAR VIVANCO, San Diego, CA (US); Tao WANG, Sunnyvale, CA (US); Jian LIANG, San Diego, CA (US); Xiayang ZHAO, San Diego, CA (US); Jing ZHOU, San Diego, CA (US); Srihari Babu ALLA, San Diego, CA (US); Biranchi Narayan NAYAK, San Jose, CA (US); Jacob Don GARCIA, Longmont, CO (US)

(21) Appl. No.: 19/209,469

(22) Filed: May 15, 2025

(51) Int. Cl. G06T 15/40; G06T 1/20; G06T 15/00

(52) U.S. Cl. CPC G06T 15/405; G06T 1/20; G06T 15/005; G06T 2210/36

(57) ABSTRACT

This disclosure provides systems, devices, apparatus, and methods, including computer programs encoded on storage media, for binning with LRZ on stencil enabled surfaces. A graphics processor may configure, during a binning pass of image data, a depth buffer with depth data of a surface associated with a stencil buffer. The graphics processor may update, during a first render pass portion, the stencil buffer for the surface. The graphics processor may discard, during a second render pass portion after the first portion, based on the depth data, a first subset of tiles in an LRZ pass. Each first subset tile includes a first depth value that meets a threshold. The graphics processor may output, based on the LRZ pass, data of a second subset of the tiles different from the first subset. Each tile of the second subset includes a second depth value that fails to meet the threshold.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for graphics processing of image data may utilize Low Resolution Z (LRZ) passes to kill or discard tiles that are fully occluded by other portions of the image data, but may not address issues associated with stencil-enabled surfaces (e.g., where a graphics processor is prevented from killing or discarding any tiles that may potentially update a stencil. There is a need for improved LRZ techniques associated with enabled stencil.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: configure, during a binning pass associated with image data, a depth buffer with depth data of a surface, where the surface is associated with a stencil buffer, configured to update, during a first portion of a render pass, the stencil buffer for the surface, configured to discard, during a second portion of the render pass subsequent to the first portion of the render pass and based on the depth data, a first subset of a set of tiles in an LRZ pass, where each tile of the first subset includes a first depth value that meets a threshold, and configured to output, based on the LRZ pass, data associated with a second subset of the set of tiles that is different from the first subset, where each tile of the second subset includes a second depth value that fails to meet the threshold.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 illustrates an example of disabled LRZ in the presence of a stencil-enabled surface, in accordance with one or more techniques of this disclosure.

FIG. 5 illustrates examples of enabled and disabled LRZ based on presence of a stencil for a surface, in accordance with one or more techniques of this disclosure.

FIG. 6 illustrates an example of enabled LRZ based on the presence of a stencil-enabled surface, in accordance with one or more techniques of this disclosure.

FIG. 7 illustrates an example of binning with LRZ on stencil enabled surfaces in accordance with one or more techniques of this disclosure.

FIG. 8 is a call flow diagram illustrating example communications between a CPU and a graphics processor in accordance with one or more techniques of this disclosure.

FIG. 9 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the term “overdraw” may refer to rendering of tiles for image content that is not viewable in an image frame, e.g., based on occlusion of the tiles or image content. As used herein, the term “stencil buffer” may refer to a buffer (e.g., a utility or auxiliary buffer), associated with operations that reject or hold information for parts of image data, which used may be used to store the information as updates or writes to the buffer. As used herein, the terms “LRZ” and “LRZ pass” (also known as a draw order independent depth rejection) may refer to object depth determination and depth testing by which removal and/or rejection (e.g., “killing”) of an LRZ tile from image content to be rendered may be performed based on occlusion of the LRZ tile by other image content and/or the depth of the LRZ tile relative to an LRZ tile resolution. As used herein, the terms “tile” or “LRZ tile” may refer to a grouping of sample blocks of image content. As used herein, the terms “depth buffer” or “LRZ buffer” may refer to a buffer or data structure used to store depth information of image content associated with an LRZ pass during a binning pass. As used herein, the term “binning pass” may refer to tiled rendering operations in which an image or image data can be divided into different bins or tiles. In some aspects, during a binning pass, a visibility stream can be constructed where visible primitives or draw calls can be identified (e.g., via LRZ). As used herein, the term “render pass” may refer to a set of operations, performed on a per-bin basis, by which visible draws, primitives, fragments, and the like, are rendered to the render target.

In the context of rendering for image content, a surface may be downscaled by fixed function blocks (e.g., a rasterizer, an LRZ pass, and/or the like) to cover fewer fragments. This may reduce the workload for fixed function blocks, as well as the number of iterations for a fragment shader. When an LRZ buffer is built on a stencil-enabled surface in a binning pass, the built-up depth buffer may kill tiles that could potentially contribute to the stencil buffer. Thus, LRZ updates may be disabled on stencil enabled surfaces, or may be overwritten with stencil buffer updates. This may result in overdraw tiles for image content that is not viewable in an image frame, which decreases rendering efficiency and increases power usage at the device.

Aspects herein enable LRZ on stencil-enabled surfaces. In order to do so, aspects herein may allow LRZ-killed tiles to update the stencil buffer, and then drop the LRZ-killed tiles after the stencil buffer is updated to reduce overdraw. The aspects for binning with LRZ on stencil enabled surfaces may allow for stencil buffer updates, while also discarding or killing tiles, which fail LRZ depth tests, at the render backend, e.g., by a fragment shader. Aspects include providing indications of tiles to be discarded or killed to the render backend.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

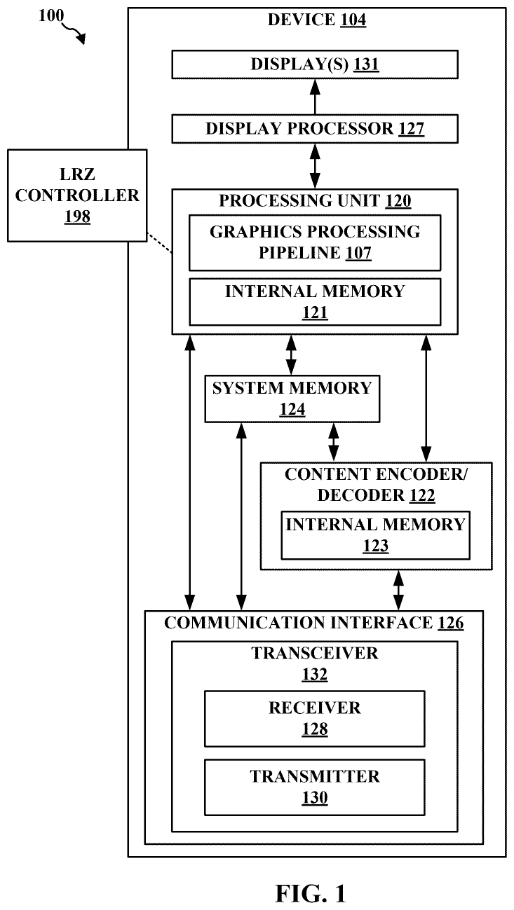

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an LRZ controller 198 configured to configure, during a binning pass associated with image data, a depth buffer with depth data of a surface, where the surface is associated with a stencil buffer, configured to update, during a first portion of a render pass, the stencil buffer for the surface, configured to discard, during a second portion of the render pass subsequent to the first portion of the render pass and based on the depth data, a first subset of a set of tiles in an LRZ pass, where each tile of the first subset includes a first depth value that meets a threshold, and configured to output, based on the LRZ pass, data associated with a second subset of the set of tiles that is different from the first subset, where each tile of the second subset includes a second depth value that fails to meet the threshold. The LRZ controller 198 may be further configured to output, prior to discarding the first subset, the first subset of the set of tiles to the render backend. The LRZ controller 198 may be further configured to process, at a fragment shader of the render backend and according to the fragment shading, a set of fragments associated with the second subset of the set of tiles and the image data. The LRZ controller 198 may be further configured to obtain a first configuration associated with the stencil buffer, where the surface is associated with the stencil buffer based on the first configuration, and to obtain a second configuration associated with the LRZ pass, where at least one of a generation of the set of tiles or the configuration of the depth buffer is based on the second configuration. The LRZ controller 198 may be further configured to set, based on the first configuration, a hardware register corresponding to the stencil buffer with a value. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

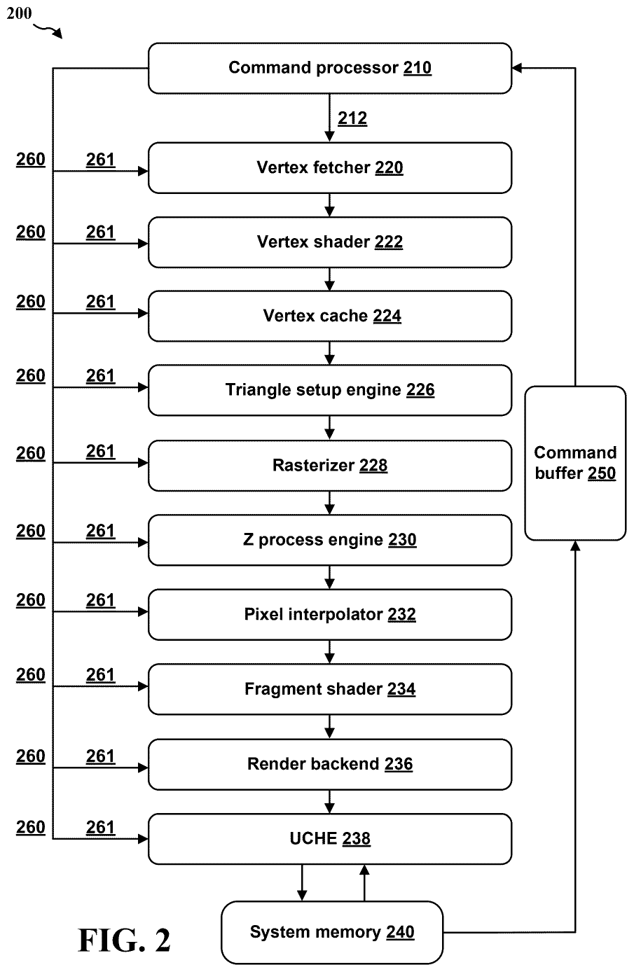

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

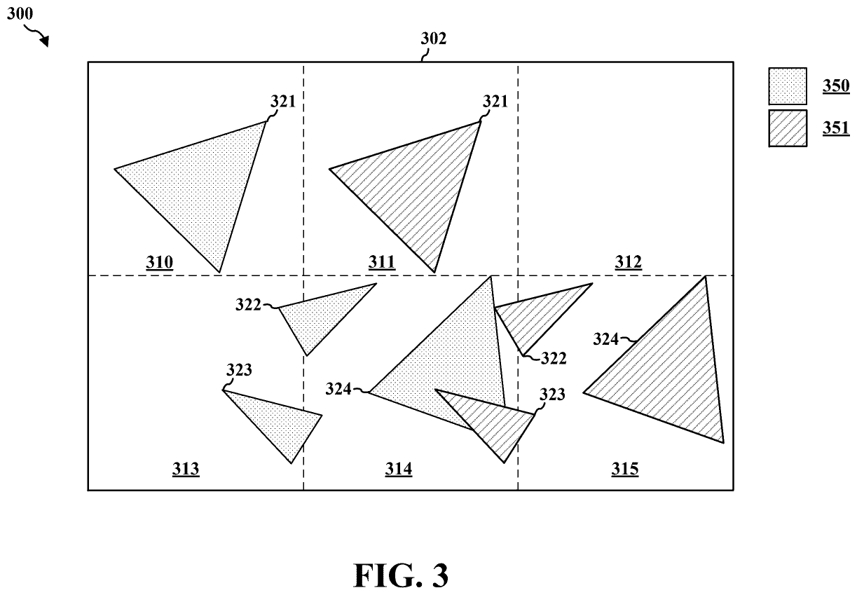

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

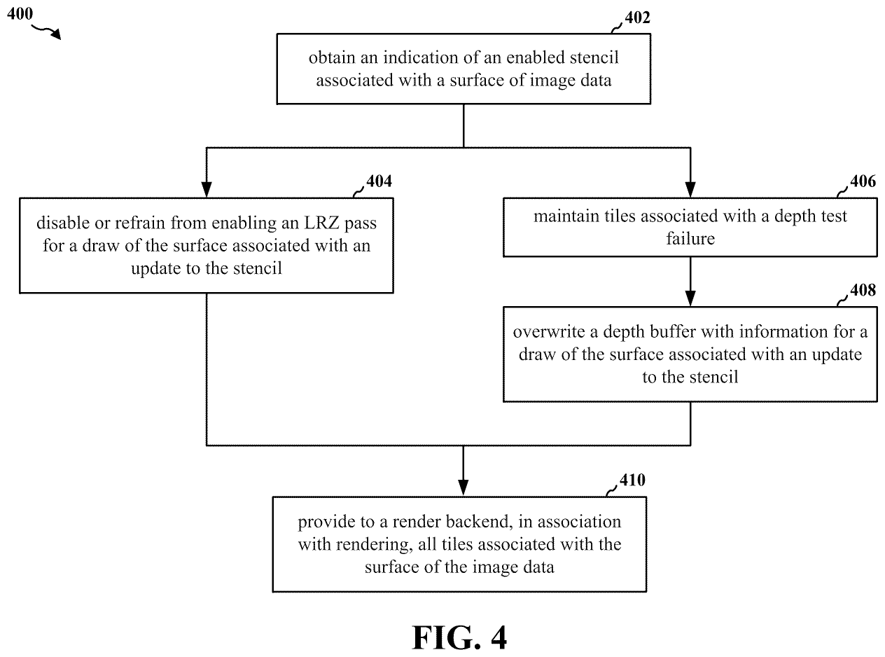

FIG. 4 illustrates a diagram 400 of an example of disabled LRZ in the presence of a stencil-enabled surface, in accordance with one or more techniques of this disclosure. The example rendering based on an LRZ pass may be performed by a graphics processor, e.g., an apparatus for graphics processing, a GPU, a CPU, a wireless communication device, and the like.

For instance, the graphics processor may obtain (at 402) an indication of an enabled stencil associated with a surface of image data. Various aspects may provide for the graphics processor either to disable or not enable LRZ, or to overwrite a depth buffer with stencil information.

As one example, the graphics processor may disable or refrain from enabling (at 404) an LRZ pass for a draw of the surface associated with an update to the stencil. As another example, the graphics processor may maintain (at 406) tiles associated with a depth test failure (e.g., via an LRZ pass), and may overwrite (at 408) depth buffer with stencil information for a draw of the surface associated with an update to the stencil. That is, utilization of LRZ may be disabled, or ignored and overwriting, at the graphics processor to avoid discarding or killing tiles that may potentially update a stencil that is enabled for a surface.

The graphics processor may provide (at 410) to a render backend, in association with rendering, all tiles associated with the surface of the image data. As an example, the graphics processor may provide tiles for which an LRZ pass was not performed or tiles based on an overwritten depth buffer to a render backend for rendering. This may result in overdraw tiles for image content that is not viewable in an image frame, which decreases rendering efficiency and increases power usage at the device.

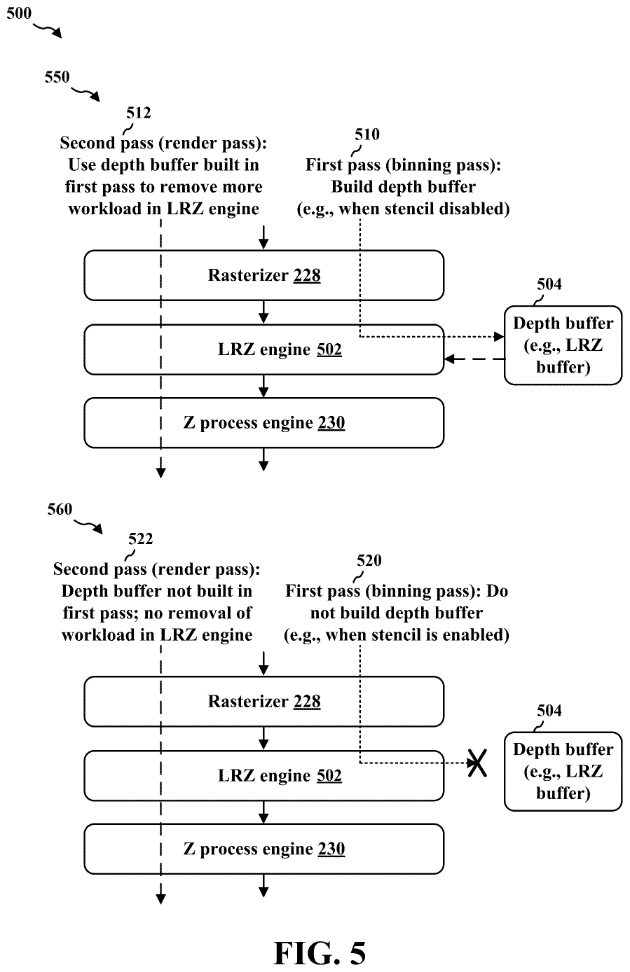

FIG. 5 illustrates a diagram 500 of examples of enabled and disabled LRZ based on presence of a stencil for a surface, in accordance with one or more techniques of this disclosure. Diagram 500 is shown with reference to an example GPU, e.g., the GPU 200 in FIG. 2, as well as an LRZ engine 502. In diagram 500, a configuration 550 with a disabled stencil and a depth buffer 504 that is built and a configuration 560 with an enabled stencil and the depth buffer 504 that is not built are provided.

In the configuration 550, a stencil or stencil buffer associated with a surface of image data may be disabled. A first pass 510 (e.g., a binning pass) may be performed. In the illustrated example, subsequent to the rasterizer 228 performing a rasterization of the image data, the LRZ engine 502 may build or configure the depth buffer 504 (e.g., with indicia of depth data for a surface) based on an LRZ pass. In a second pass 512 (e.g., a render pass), the LRZ engine 502 may utilize the depth data in the depth buffer 504 to remove additional workload (e.g., to discard a set or subset of tiles, associated with the image data, in an LRZ pass).

In the configuration 560, a stencil or stencil buffer associated with a surface of image data may be enabled. A first pass 520 (e.g., a binning pass) may be performed. In the illustrated example, subsequent to the rasterizer 228 performing a rasterization of the image data, the LRZ engine 502 may not build or configure the depth buffer 504 (e.g., with indicia of depth data for a surface) based on the stencil or the stencil buffer being enabled. In a second pass 522 (e.g., a render pass), the LRZ engine 502 may not utilize depth data in the depth buffer 504 to remove additional workload as the depth buffer 504 was not built or configured in the first pass.

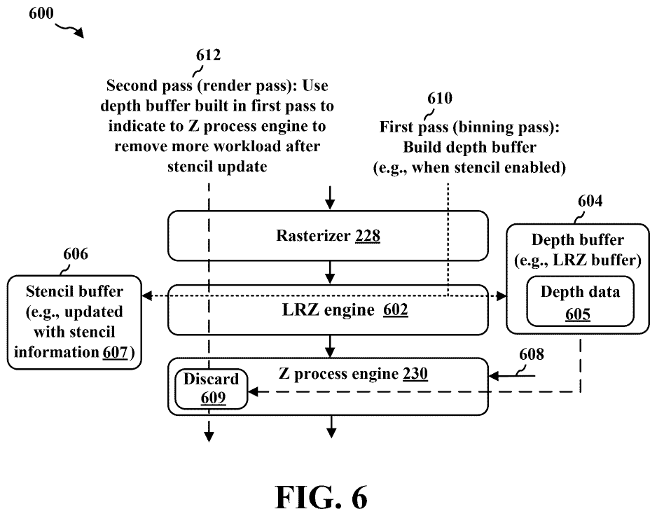

FIG. 6 illustrates a diagram 600 of an example of enabled LRZ based on the presence of a stencil-enabled surface, in accordance with one or more techniques of this disclosure. Diagram 600 is shown with reference to an example GPU, e.g., the GPU 200 in FIG. 2, as well as an LRZ engine 602. In diagram 600, a configuration with a stencil buffer 606 that is enabled, and a depth buffer 604 that is built, is provided.

In the illustrated configuration, according to aspects, a stencil and/or the stencil buffer 606 associated with a surface of image data may be enabled. A first pass 610 (e.g., a binning pass) may be performed. In the illustrated example, subsequent to the rasterizer 228 performing a rasterization of the image data, the LRZ engine 602 may build or configure the depth buffer 604 (e.g., with indicia of depth data 605 for a surface) based on an LRZ pass. The LRZ engine 602 may also be configured to update the stencil buffer 606 (that is enabled) with stencil information 607 associated with the surface of the image data. In a second pass 612 (e.g., a render pass), the Z process engine 230 may utilize the depth data 605 in the depth buffer 604, configured or built in the first pass 610, to remove additional workload (e.g., to discard (at 609) a set or subset of tiles, associated with the image data). In some aspects, an indication 608 may be provided to the Z process engine 230 to indicate that the depth data 605 is available for utilization in the second pass 612. In some aspects, the depth data 605 may be the indication 608.

Accordingly, when a stencil or stencil buffer (e.g., the stencil buffer 606) is enabled for a surface, in aspects herein, the depth buffer 604 may be updated in the first pass 610, and workload discarding (at 609) (e.g., based on the depth data 605) may be deferred, until the stencil buffer 606 is updated, and performed in the Z process engine 230 during the second pass 612.

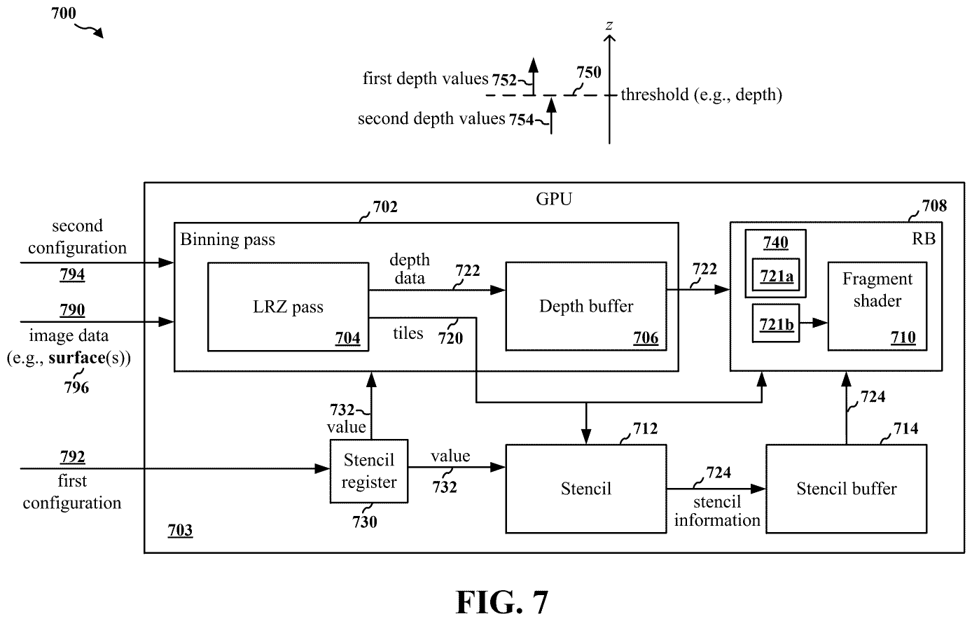

FIG. 7 illustrates a diagram 700 of an example of binning with LRZ on stencil enabled surfaces in accordance with one or more techniques of this disclosure. Diagram 700 is shown in the context of a graphics processor 703. Diagram 700 may be an aspect of diagram 600 in FIG. 6.

The graphics processor may be configured to receive, e.g., from a CPU, image data 790. In aspects, the image data 790 may include or be associated with a surface(s) 796 (e.g., an aspect of image or surface 300 in FIG. 3), and may be associated with an application, such as a software application for which the image data 790 may be processed and/or rendered by the graphics processor 703 (e.g., via the render backend (RB) 708).

During a binning pass 702, an LRZ pass 704 may utilize the image data 790, e.g., as divided into a set of tiles 720 (e.g., LRZ tiles), to generate depth data and to configure a depth buffer 706 with depth data 722. In aspects, the depth data 722 may be associated with the surface(s) 796 of the image data 790, and the graphics processor 703 may configure the depth buffer 706 with the depth data 722 based on a second configuration 794. In some aspects, the second configuration 794 may indicate that all of the set of tiles 720 will be provided or output to the RB 708 (e.g., to a fragment shader 710 for fragment shading).

In some aspects, a surface(s) 796 of the image data 790 may be associated with a stencil 712 (e.g., the stencil 712 may be enabled for the surface(s) 796 of the image data 790). A stencil register 730 may be configured with a value 732 based on the first configuration 792 (e.g., obtained from an application, a graphics driver, and/or the like) that indicates such an enablement or association with the surface(s) 796 of the image data 790. In aspects, even when the value 732 indicates the enablement or association with the surface(s) 796, the second configuration 794 (e.g., obtained from an application, a graphics driver, and/or the like) may indicate that indicate that all of the set of tiles 720 will be provided to the RB 708, and the LRZ pass 704 may configure the depth buffer 706 with the depth data 722.

The depth data 722 and/or the set of tiles 720 associated with the LRZ pass 704 may be provided (e.g., output) to the RB 708, and the RB 708 may be configured to discard (at 740) or kill a first subset 721a of the set of tiles 720 based on the depth data 722 (e.g., each tile of the first subset 721a includes a first depth value 752 that meets a threshold 750 (e.g., a depth threshold), such as being indicative of full occlusion or an overdraw).

In aspects, the graphics processor 703 may output, based on the LRZ pass 704 depth data 722 associated with a second subset 721b of the set of tiles 720 that is different from the first subset 721a, where each tile of the second subset 721b includes a second depth value 754 that fails to meet the threshold 750 (e.g., the second depth value 754 indicates that the second subset 721b should be rendered). The depth data 722 of the surviving tiles of the set of tiles 720, a second subset 721b, may be provided to the fragment shader 710 for processing via fragment shading, while the fragment shader 710 may skip such processing of the first subset 721a. In aspects, the stencil information 724 may be utilized for the rendering with the depth data 722 of the second subset 721b.

Accordingly, the set of tiles 720 is available for the stencil 712 to update the stencil buffer 714, while the depth data 722 of the depth buffer 706 remains available for depth testing at the RB 708.

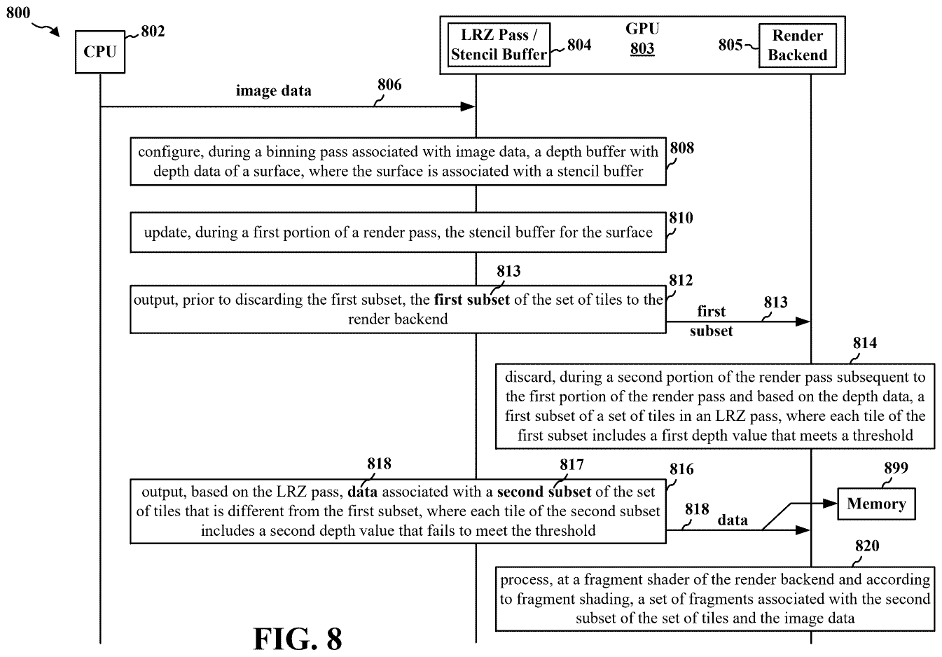

FIG. 8 is a call flow diagram 800 illustrating example communications between a CPU 802 and a graphics processor 803 in accordance with one or more techniques of this disclosure. In aspects, call flow diagram 800 is described for binning with LRZ on stencil enabled surfaces. In an example, the graphics processor 803 may be or include the processing unit 120/the LRZ controller 198. In aspects, the graphics processor 803 comprises a wireless communication device that is configured to perform the call flow diagram 800.

The graphics processor 803 may be configured to receive, and the CPU 802 may be configured to transmit, image data 806. In aspects, the image data 806 may be associated with an application, such as a software application for which the image data 806 may be processed and rendered by the graphics processor 803 (e.g., via the render backend 805).

The graphics processor 803 (e.g., via an LRZ pass of the LRZ pass and stencil buffer 804) may be configured to configure (at 808), during a binning pass associated with the image data 806, a depth buffer with depth data of a surface. In aspects, the surface may be associated with a stencil buffer (e.g., a stencil buffer of the LRZ pass and stencil buffer 804). In some aspect, where a hardware register corresponding to the stencil buffer (e.g., a stencil buffer of the LRZ pass and stencil buffer 804) is set with a value based on a first configuration, to configure (at 808) the depth buffer, the graphics processor 803 may configure (at 808) the depth buffer further based on the value of the hardware register corresponding to the stencil buffer (e.g., a stencil buffer of the LRZ pass and stencil buffer 804).

The graphics processor 803 may be configured to update (at 810), during a first portion of a render pass, the stencil buffer (e.g., a stencil buffer of the LRZ pass and stencil buffer 804) for the surface.

In some aspects, the graphics processor 803 may be configured to obtain a first configuration associated with the stencil buffer (e.g., a stencil buffer of the LRZ pass and stencil buffer 804). In aspects, the surface may be associated with the stencil buffer (e.g., a stencil buffer of the LRZ pass and stencil buffer 804) based on the first configuration. In some aspects, the graphics processor 803 may be configured to obtain a second configuration associated with the LRZ pass. In aspects, at least one of a generation of the set of tiles or the configuration of the depth buffer may be based on the second configuration.

The graphics processor 803 may be configured to set, based on the first configuration, a hardware register corresponding to the stencil buffer (e.g., a stencil buffer of the LRZ pass and stencil buffer 804) with a value. In such aspects, to configure the depth buffer, the graphics processor 803 may be configured to configure the depth buffer further based on the value of the hardware register corresponding to the stencil buffer (e.g., a stencil buffer of the LRZ pass and stencil buffer 804).

The graphics processor 803 may be configured to output (at 812) a first subset 813 of a set of tiles, prior to discarding (at 814) the first subset 813 of the set of tiles, to the render backend 805.

The graphics processor 803 may be configured to discard (at 814), during a second portion of the render pass subsequent to the first portion of the render pass and based on the depth data, the first subset 813 of the set of tiles in an LRZ pass. In aspects, each tile of the first subset 813 may include a first depth value that meets a threshold. In some aspects, to discard (at 814), subsequent to the first portion of the render pass, the first subset 813 of the set of tiles, the graphics processor 803 may be configured to discard (at 814) the first subset 813 of the set of tiles prior to fragment shading. In some aspects, to discard (at 814) the first subset 813 of the set of tiles, the graphics processor 803 may be configured to discard (at 814) the first subset 813 of the set of tiles by the render backend 805.

The graphics processor 803 may be configured to output (at 816), based on the LRZ pass, data 818 associated with a second subset 817 of the set of tiles that is different from the first subset 813. In aspects, each tile of the second subset 817 may include a second depth value that fails to meet the threshold. In some aspects, to output (at 816) the data 818 associated with the second subset 817 of the set of tiles, the graphics processor 803 may be configured to output (at 816) the data 818 associated with the second subset 817 of the set of tiles based on the second configuration. In some aspects, to output (at 816) the data 818 associated with the second subset 817 of the set of tiles, the graphics processor 803 may be configured to provide, to a fragment shader, the data 818 associated with the second subset 817 of the set of tiles. In some aspects, to output (at 816) the data 818 associated with the second subset 817 of the set of tiles, the graphics processor 803 may be configured to store, in the memory 899, the data 818 associated with the second subset 817 of the set of tiles. The second depth value included for each tile of the first subset 813 of the set of tiles may be associated with a respective occlusion of the tile based on the threshold (e.g., determined during an LRZ pass and stored at a depth buffer).

The graphics processor 803 may be configured to process (at 820), at a fragment shader of the render backend 805 and according to the fragment shading, a set of fragments associated with a second subset 817 of the set of tiles and the image data 806.

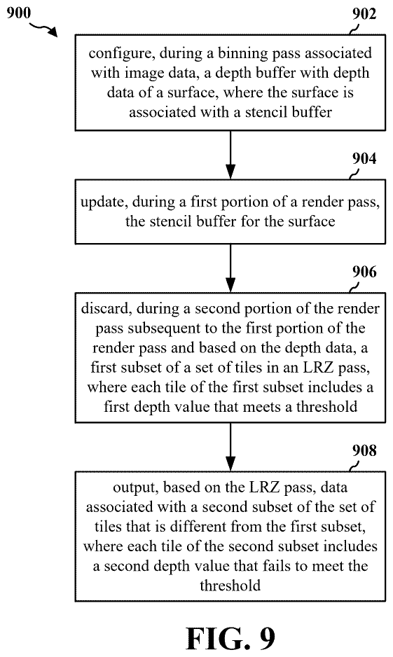

FIG. 9 is a flowchart 900 of an example method of graphics processing in accordance with one or more techniques of this disclosure. The method may be for binning with LRZ on stencil enabled surfaces and may be performed by an apparatus, such as an apparatus for graphics processing, a GPU, a CPU, a wireless communication device, and the like, as used in connection with the aspects of FIGS. 1-6.

At 902, the apparatus may configure, during a binning pass associated with image data, a depth buffer with depth data of a surface, where the surface is associated with a stencil buffer. For example, referring to FIG. 8, the graphics processor 803 may be configured to receive, and the CPU 802 may be configured to transmit, image data 806 (e.g., 790 in FIG. 7). In aspects, the image data 806 (e.g., 790 in FIG. 7) may be associated with an application, such as a software application for which the image data 806 (e.g., 790 in FIG. 7) may be processed and rendered by the graphics processor 803 (e.g., via the render backend 805 (e.g., via 708 in FIG. 7)).

The graphics processor 803 (e.g., via an LRZ pass (e.g., via 602 in FIG. 6; at 704 in FIG. 7) of the LRZ pass and stencil buffer 804 (e.g., via 602, 606 in FIG. 6; 704 and 714 in FIG. 7)) may be configured to configure (at 808), during a binning pass (e.g., at 610 in FIG. 6; at 702 in FIG. 7) associated with the image data 806 (e.g., 790 in FIG. 7), a depth buffer (e.g., 604 in FIG. 6; 706 in FIG. 7) with depth data (e.g., 605 in FIG. 6; 722 in FIG. 7) of a surface (e.g., 796 in FIG. 7). In aspects, the surface (e.g., 796 in FIG. 7) may be associated with a stencil buffer (e.g., 606 in FIG. 6; 714 in FIG. 7) (e.g., a stencil buffer of the LRZ pass and stencil buffer 804 (e.g., via 602, 606 in FIG. 6; 704 and 714 in FIG. 7)). In some aspect, where a hardware register (e.g., 730 in FIG. 7) corresponding to the stencil buffer (e.g., 606 in FIG. 6; 714 in FIG. 7) (e.g., a stencil buffer of the LRZ pass and stencil buffer 804 (e.g., via 602, 606 in FIG. 6; 704 and 714 in FIG. 7)) is set with a value (e.g., 732 in FIG. 7) based on a first configuration (e.g., 792 in FIG. 7), to configure (at 808) the depth buffer (e.g., 604 in FIG. 6; 706 in FIG. 7), the graphics processor 803 may configure (at 808) the depth buffer (e.g., 604 in FIG. 6; 706 in FIG. 7) further based on the value (e.g., 732 in FIG. 7) of the hardware register (e.g., 730 in FIG. 7) corresponding to the stencil buffer (e.g., 606 in FIG. 6; 714 in FIG. 7) (e.g., a stencil buffer of the LRZ pass and stencil buffer 804 (e.g., via 602, 606 in FIG. 6; 704 and 714 in FIG. 7)). In an example, 902 may be performed by the LRZ controller 198.

At 904, the apparatus may update, during a first portion of a render pass, the stencil buffer for the surface. For example, referring to FIG. 8, the graphics processor 803 may be configured to update (at 810), during a first portion of a render pass (e.g., 610 in FIGS. 6, 702 in FIG. 7), the stencil buffer (e.g., 606 in FIG. 6; 714 in FIG. 7) (e.g., a stencil buffer of the LRZ pass and stencil buffer 804 (e.g., via 602, 606 in FIG. 6; 704 and 714 in FIG. 7)) for the surface (e.g., 796 in FIG. 7).

In some aspects, the graphics processor 803 may be configured to obtain a first configuration (e.g., 792 in FIG. 7) associated with the stencil buffer (e.g., 606 in FIG. 6; 714 in FIG. 7) (e.g., a stencil buffer of the LRZ pass and stencil buffer 804 (e.g., via 602, 606 in FIG. 6; 704 and 714 in FIG. 7)). In aspects, the surface (e.g., 796 in FIG. 7) may be associated with the stencil buffer (e.g., 606 in FIG. 6; 714 in FIG. 7) (e.g., a stencil buffer of the LRZ pass and stencil buffer 804 (e.g., via 602, 606 in FIG. 6; 704 and 714 in FIG. 7)) based on the first configuration (e.g., 792 in FIG. 7). In some aspects, the graphics processor 803 may be configured to obtain a second configuration (e.g., 794 in FIG. 7) associated with the LRZ pass (e.g., via 602 in FIG. 6; at 704 in FIG. 7). In aspects, at least one of a generation of the set of tiles (e.g., 720 in FIG. 7) or the configuration of the depth buffer (e.g., 604 in FIG. 6; 706 in FIG. 7) may be based on the second configuration (e.g., 794 in FIG. 7).

The graphics processor 803 may be configured to set, based on the first configuration (e.g., 792 in FIG. 7), a hardware register (e.g., 730 in FIG. 7) corresponding to the stencil buffer (e.g., 606 in FIG. 6; 714 in FIG. 7) (e.g., a stencil buffer of the LRZ pass and stencil buffer 804 (e.g., via 602, 606 in FIG. 6; 704 and 714 in FIG. 7)) with a value (e.g., 732 in FIG. 7). In such aspects, to configure the depth buffer (e.g., 604 in FIG. 6; 706 in FIG. 7), the graphics processor 803 may be configured to configure the depth buffer (e.g., 604 in FIG. 6; 706 in FIG. 7) further based on the value (e.g., 732 in FIG. 7) of the hardware register (e.g., 730 in FIG. 7) corresponding to the stencil buffer (e.g., 606 in FIG. 6; 714 in FIG. 7) (e.g., a stencil buffer of the LRZ pass and stencil buffer 804 (e.g., via 602, 606 in FIG. 6; 704 and 714 in FIG. 7)). In an example, 904 may be performed by the LRZ controller 198.

At 906, the apparatus may discard, during a second portion of the render pass subsequent to the first portion of the render pass and based on the depth data, a first subset of a set of tiles in an LRZ pass, where each tile of the first subset includes a first depth value that meets a threshold. For example, referring to FIG. 8, the graphics processor 803 may be configured to discard (at 814) (e.g., at 609 in FIG. 6; at 740 in FIG. 7), during a second portion of the render pass (e.g., 612 in FIG. 6, via 708 in FIG. 7) subsequent to the first portion of the render pass (e.g., 610 in FIGS. 6, 702 in FIG. 7) and based on the depth data (e.g., 605 in FIG. 6; 722 in FIG. 7), the first subset 813 (e.g., 721a in FIG. 7) of the set of tiles (e.g., 720 in FIG. 7) in an LRZ pass (e.g., via 602 in FIG. 6; at 704 in FIG. 7). In aspects, each tile of the first subset 813 (e.g., 721a in FIG. 7) may include a first depth value (e.g., 752 in FIG. 7) that meets a threshold (e.g., 750 in FIG. 7). In some aspects, to discard (at 814) (e.g., at 609 in FIG. 6; at 740 in FIG. 7), subsequent to the first portion of the render pass (e.g., 610 in FIGS. 6, 702 in FIG. 7), the first subset 813 (e.g., 721a in FIG. 7) of the set of tiles (e.g., 720 in FIG. 7), the graphics processor 803 may be configured to discard (at 814) (e.g., at 609 in FIG. 6; at 740 in FIG. 7) the first subset 813 (e.g., 721a in FIG. 7) of the set of tiles (e.g., 720 in FIG. 7) prior to fragment shading (e.g., via 710 in FIG. 7). In some aspects, to discard (at 814) (e.g., at 609 in FIG. 6; at 740 in FIG. 7) the first subset 813 (e.g., 721a in FIG. 7) of the set of tiles (e.g., 720 in FIG. 7), the graphics processor 803 may be configured to discard (at 814) (e.g., at 609 in FIG. 6; at 740 in FIG. 7) the first subset 813 (e.g., 721a in FIG. 7) of the set of tiles (e.g., 720 in FIG. 7) by the render backend 805 (e.g., 708 in FIG. 7). In an example, 906 may be performed by the LRZ controller 198.

At 908, the apparatus may output, based on the LRZ pass, data associated with a second subset of the set of tiles that is different from the first subset, where each tile of the second subset includes a second depth value that fails to meet the threshold. For example, referring to FIG. 8, the graphics processor 803 may be configured to output (at 816), based on the LRZ pass (e.g., via 602 in FIG. 6; at 704 in FIG. 7), data 818 (e.g., 722 in FIG. 7) associated with a second subset 817 (e.g., 721b in FIG. 7) of the set of tiles (e.g., 720 in FIG. 7) that is different from the first subset 813 (e.g., 721a in FIG. 7). In aspects, each tile of the second subset 817 (e.g., 721b in FIG. 7) may include a second depth value (e.g., 754 in FIG. 7) that fails to meet the threshold (e.g., 750 in FIG. 7). In some aspects, to output (at 816) the data 818 (e.g., 722 in FIG. 7) associated with the second subset 817 (e.g., 721b in FIG. 7) of the set of tiles (e.g., 720 in FIG. 7), the graphics processor 803 may be configured to output (at 816) the data 818 (e.g., 722 in FIG. 7) associated with the second subset 817 (e.g., 721b in FIG. 7) of the set of tiles (e.g., 720 in FIG. 7) based on the second configuration (e.g., 794 in FIG. 7). In some aspects, to output (at 816) the data 818 (e.g., 722 in FIG. 7) associated with the second subset 817 (e.g., 721b in FIG. 7) of the set of tiles (e.g., 720 in FIG. 7), the graphics processor 803 may be configured to provide, to a fragment shader (e.g., 710 in FIG. 7), the data 818 (e.g., 722 in FIG. 7) associated with the second subset 817 (e.g., 721b in FIG. 7) of the set of tiles (e.g., 720 in FIG. 7). In some aspects, to output (at 816) the data 818 (e.g., 722 in FIG. 7) associated with the second subset 817 (e.g., 721b in FIG. 7) of the set of tiles (e.g., 720 in FIG. 7), the graphics processor 803 may be configured to store, in the memory 899, the data 818 (e.g., 722 in FIG. 7) associated with the second subset 817 (e.g., 721b in FIG. 7) of the set of tiles (e.g., 720 in FIG. 7). The second depth value (e.g., 754 in FIG. 7) included for each tile of the first subset 813 (e.g., 721a in FIG. 7) of the set of tiles (e.g., 720 in FIG. 7) may be associated with a respective occlusion of the tile based on the threshold (e.g., 750 in FIG. 7) (e.g., determined during an LRZ pass (e.g., via 602 in FIG. 6; at 704 in FIG. 7) and stored at a depth buffer (e.g., 604 in FIG. 6; 706 in FIG. 7)).

The graphics processor 803 may be configured to process (at 820), at a fragment shader (e.g., via 710 in FIG. 7) of the render backend 805 (e.g., 708 in FIG. 7) and according to the fragment shading (e.g., via 710 in FIG. 7), a set of fragments associated with a second subset 817 (e.g., via 721b in FIG. 7) of the set of tiles (e.g., 720 in FIG. 7) and the image data 806 (e.g., 790 in FIG. 7). In an example, 908 may be performed by the LRZ controller 198.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for configuring, during a binning pass associated with image data, a depth buffer with depth data of a surface, where the surface is associated with a stencil buffer, means for updating, during a first portion of a render pass, the stencil buffer for the surface, means for discarding, during a second portion of the render pass subsequent to the first portion of the render pass and based on the depth data, a first subset of a set of tiles in an LRZ pass, where each tile of the first subset includes a first depth value that meets a threshold, and means for outputting, based on the LRZ pass, data associated with a second subset of the set of tiles that is different from the first subset, where each tile of the second subset includes a second depth value that fails to meet the threshold. The apparatus may further include means for outputting, prior to discarding the first subset, the first subset of the set of tiles to the render backend, and means for processing, at a fragment shader of the render backend and according to the fragment shading, a set of fragments associated with the second subset of the set of tiles and the image data. The apparatus may further include means for obtaining a first configuration associated with the stencil buffer, where the surface is associated with the stencil buffer based on the first configuration, and means for obtaining a second configuration associated with the LRZ pass, where at least one of a generation of the set of tiles or the configuration of the depth buffer is based on the second configuration. The apparatus may further include means for setting, based on the first configuration, a hardware register corresponding to the stencil buffer with a value.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is method of graphics processing, comprising: configuring, during a binning pass associated with image data, a depth buffer with depth data of a surface, wherein the surface is associated with a stencil buffer; updating, during a first portion of a render pass, the stencil buffer for the surface; discarding, during a second portion of the render pass subsequent to the first portion of the render pass and based on the depth data, a first subset of a set of tiles in a low resolution Z (LRZ) pass, wherein each tile of the first subset includes a first depth value that meets a threshold; and outputting, based on the LRZ pass, data associated with a second subset of the set of tiles that is different from the first subset, wherein each tile of the second subset includes a second depth value that fails to meet the threshold.

Aspect 2 is the method of aspect 1, wherein discarding, subsequent to the first portion of the render pass, the first subset of the set of tiles includes discarding the first subset of the set of tiles prior to fragment shading.

Aspect 3 is the method of aspect 2, wherein discarding the first subset of the set of tiles includes discarding the first subset of the set of tiles by a render backend.

Aspect 4 is the method of aspect 3, further comprising: outputting, prior to discarding the first subset, the first subset of the set of tiles to the render backend.

Aspect 5 is the method of any of aspects 3 and 4, further comprising: processing, at a fragment shader of the render backend and according to the fragment shading, a set of fragments associated with the second subset of the set of tiles and the image data.

Aspect 6 is the method of any of aspects 1 to 5, wherein the second depth value included for each tile of the first subset of the set of tiles is associated with a respective occlusion of the tile based on the threshold.

Aspect 7 is the method of any of aspects 1 to 6, further comprising: obtaining a first configuration associated with the stencil buffer, wherein the surface is associated with the stencil buffer based on the first configuration; and obtaining a second configuration associated with the LRZ pass, wherein at least one of a generation of the set of tiles or the configuration of the depth buffer is based on the second configuration.

Aspect 8 is the method of aspect 7, wherein outputting the data associated with the second subset of the set of tiles includes outputting the data associated with the second subset of the set of tiles based on the second configuration.

Aspect 9 is the method of any of aspects 7 and 8, further comprising: setting, based on the first configuration, a hardware register corresponding to the stencil buffer with a value, wherein configuring the depth buffer is further based on the value of the hardware register corresponding to the stencil buffer.

Aspect 10 is the method of any of aspects 1 to 9, wherein outputting the data associated with the second subset of the set of tiles includes: providing, to a fragment shader, the data associated with the second subset of the set of tiles; or storing, in a memory, the data associated with the second subset of the set of tiles.

Aspect 11 is an apparatus for graphics processing comprising a processor coupled to a memory and, based on information stored in the memory, the processor is configured to implement a method as in any of aspects 1-10.

Aspect 12 may be combined with aspect 11 and comprises that the apparatus is a wireless communication device.

Aspect 13 is an apparatus for graphics processing comprising means for implementing a method as in any of aspects 1-10.

Aspect 14 is a computer-readable medium (e.g., a non-transitory computer readable-medium) storing computer executable code, the computer executable code, when executed by a processor, causes the processor to implement a method as in any of aspects 1-10.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
configure, during a binning pass associated with image data, a depth buffer with depth data of a surface, wherein the surface is associated with a stencil buffer;
update, during a first portion of a render pass, the stencil buffer for the surface;
discard, during a second portion of the render pass subsequent to the first portion of the render pass and based on the depth data, a first subset of a set of tiles in a low resolution Z (LRZ) pass, wherein each tile of the first subset includes a first depth value that meets a threshold; and
output, based on the LRZ pass, data associated with a second subset of the set of tiles that is different from the first subset, wherein each tile of the second subset includes a second depth value that fails to meet the threshold.

2. The apparatus of claim 1, wherein to discard, subsequent to the first portion of the render pass, the first subset of the set of tiles, the processor is configured to discard the first subset of the set of tiles prior to fragment shading.

3. The apparatus of claim 2, wherein to discard the first subset of the set of tiles, the processor is configured to discard the first subset of the set of tiles by a render backend.

4. The apparatus of claim 3, wherein the processor is further configured to:
output, prior to discarding the first subset, the first subset of the set of tiles to the render backend.

5. The apparatus of claim 3, wherein the processor is further configured to:
process, at a fragment shader of the render backend and according to the fragment shading, a set of fragments associated with the second subset of the set of tiles and the image data.

6. The apparatus of claim 1, wherein the second depth value included for each tile of the first subset of the set of tiles is associated with a respective occlusion of the tile based on the threshold.

7. The apparatus of claim 1, wherein the processor is further configured to:
obtain a first configuration associated with the stencil buffer, wherein the surface is associated with the stencil buffer based on the first configuration; and
obtain a second configuration associated with the LRZ pass, wherein at least one of a generation of the set of tiles or the configuration of the depth buffer is based on the second configuration.

8. The apparatus of claim 7, wherein to output the data associated with the second subset of the set of tiles, the processor is configured to output the data associated with the second subset of the set of tiles based on the second configuration.

9. The apparatus of claim 7, wherein the processor is further configured to:
set, based on the first configuration, a hardware register corresponding to the stencil buffer with a value;
wherein to configure the depth buffer, the processor is configured to configure the depth buffer further based on the value of the hardware register corresponding to the stencil buffer.

10. The apparatus of claim 1, wherein to output the data associated with the second subset of the set of tiles, the processor is configured to:
provide, to a fragment shader, the data associated with the second subset of the set of tiles; or
store, in the memory, the data associated with the second subset of the set of tiles.

11. The apparatus of claim 1, wherein the apparatus is a wireless communication device.

12. A method of graphics processing, comprising:
configuring, during a binning pass associated with image data, a depth buffer with depth data of a surface, wherein the surface is associated with a stencil buffer;
updating, during a first portion of a render pass, the stencil buffer for the surface;
discarding, during a second portion of the render pass subsequent to the first portion of the render pass and based on the depth data, a first subset of a set of tiles in a low resolution Z (LRZ) pass, wherein each tile of the first subset includes a first depth value that meets a threshold; and
outputting, based on the LRZ pass, data associated with a second subset of the set of tiles that is different from the first subset, wherein each tile of the second subset includes a second depth value that fails to meet the threshold.

13. The method of claim 12, wherein discarding, subsequent to the first portion of the render pass, the first subset of the set of tiles includes discarding the first subset of the set of tiles prior to fragment shading.

14. The method of claim 13, wherein discarding the first subset of the set of tiles includes discarding the first subset of the set of tiles by a render backend.

15. The method of claim 14, further comprising at least one of:
outputting, prior to discarding the first subset, the first subset of the set of tiles to the render backend; or
processing, at a fragment shader of the render backend and according to the fragment shading, a set of fragments associated with the second subset of the set of tiles and the image data.

16. The method of claim 12, wherein the second depth value included for each tile of the first subset of the set of tiles is associated with a respective occlusion of the tile based on the threshold.

17. The method of claim 12, further comprising:
obtaining a first configuration associated with the stencil buffer, wherein the surface is associated with the stencil buffer based on the first configuration; and
obtaining a second configuration associated with the LRZ pass, wherein at least one of a generation of the set of tiles or the configuration of the depth buffer is based on the second configuration.

18. The method of claim 17, wherein outputting the data associated with the second subset of the set of tiles includes outputting the data associated with the second subset of the set of tiles based on the second configuration; or
wherein the method further comprises:
setting, based on the first configuration, a hardware register corresponding to the stencil buffer with a value,
wherein configuring the depth buffer is further based on the value of the hardware register corresponding to the stencil buffer.

19. The method of claim 12, wherein outputting the data associated with the second subset of the set of tiles includes:
providing, to a fragment shader, the data associated with the second subset of the set of tiles; or
storing, in a memory, the data associated with the second subset of the set of tiles.

20. A computer-readable medium storing computer executable code, the computer executable code, when executed by a processor, causes the processor to:
configure, during a binning pass associated with image data, a depth buffer with depth data of a surface, wherein the surface is associated with a stencil buffer;
update, during a first portion of a render pass, the stencil buffer for the surface;
discard, during a second portion of the render pass subsequent to the first portion of the render pass and based on the depth data, a first subset of a set of tiles in a low resolution Z (LRZ) pass, wherein each tile of the first subset includes a first depth value that meets a threshold; and
output, based on the LRZ pass, data associated with a second subset of the set of tiles that is different from the first subset, wherein each tile of the second subset includes a second depth value that fails to meet the threshold.
